(19) United States
(12) Patent Application Publication
(10) Pub. No.: US 2014/0292257 A1
(43) Pub. Date: Oct. 2, 2014

(54) ELECTRONIC DEVICE AND CHARGING CIRCUIT THEREOF

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: HAI-QING ZHOU, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/225,688

(22) Filed: Mar. 26, 2014

(30) Foreign Application Priority Data
Mar. 27, 2013 (CN) 2013101016799

(51) Int. Cl. H02J 7/00

(52) U.S. Cl. CPC H02J 7/0052
USPC 320/107

(57) ABSTRACT

A charging circuit is used to charge a rechargeable battery. The charging circuit includes a control unit, a voltage conversion unit, and a charging and display unit. The control unit is used to control the voltage conversion unit to operate. The voltage conversion unit is used to convert a voltage of a power supply into a charging voltage of the rechargeable battery, and output the charging voltage to the charging and display unit. When the voltage conversion unit outputs the charging voltage, the charging and display unit charges the rechargeable battery with the charging voltage. When the voltage conversion unit does not output the charging voltage, the charging and display unit prevents a leakage of the rechargeable battery. The charging and display unit is also used to display a charging state of the rechargeable battery.

### FIELD

The present disclosure relates to electronic devices, and particularly to an electronic device with a charging circuit.

### BACKGROUND

Generally, rechargeable batteries require a dedicated charger, which is inconvenient. Therefore, there is room for improvement in the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the presented embodiments.

FIG. 1 is an isometric view of an embodiment of an electronic device comprising a charging circuit.

FIG. 2 is a block diagram of an embodiment of a charging circuit for the electronic device of FIG. 1, the charging circuit comprising a control unit, a voltage conversion unit, and a charging and display unit.

FIG. 3 is a circuit diagram of the charging and display unit of FIG. 2.

FIG. 4 is a circuit diagram of the control unit and the voltage conversion unit of FIG. 2.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references can mean “at least one.”

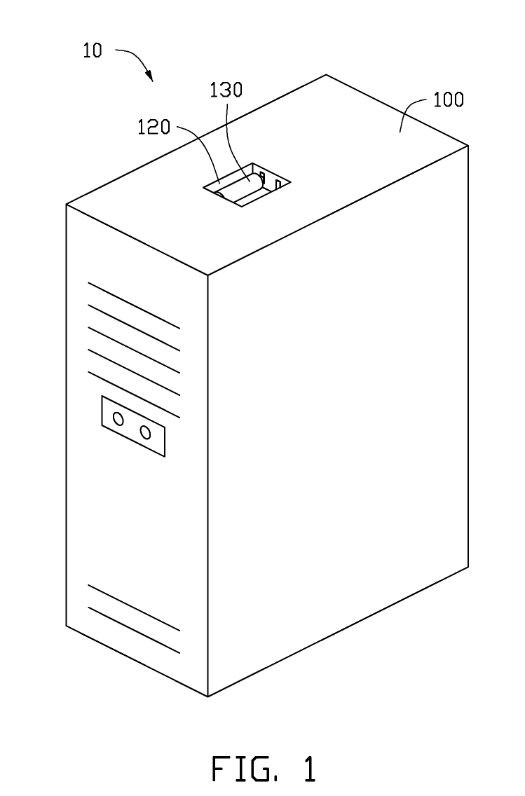

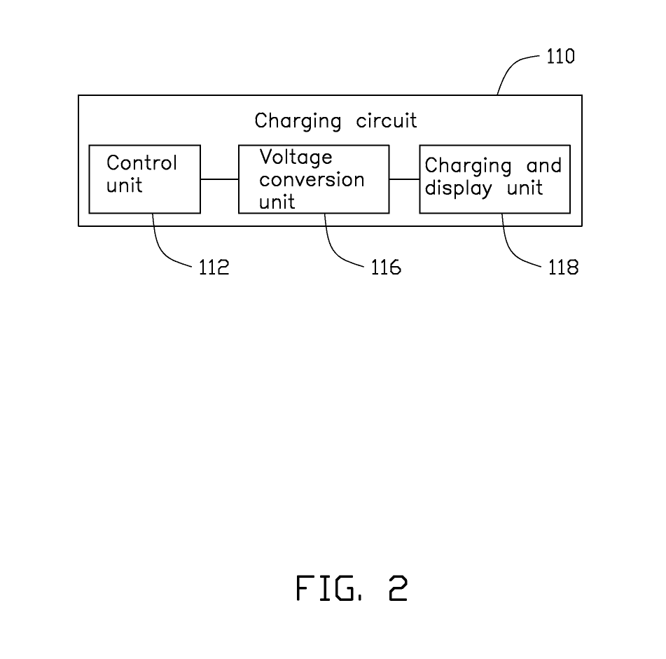

FIGS. 1 and 2 show an embodiment of an electronic device 10. The electronic device 10 comprises a shell 100 and a charging circuit 110 received in the shell 100. A receiving space 120 is defined in the shell 100 to receive a rechargeable battery 130. The rechargeable battery 130 can be electrically connected to the charging circuit 110. In one embodiment, the electronic device 10 can include a chassis of a desktop computer.

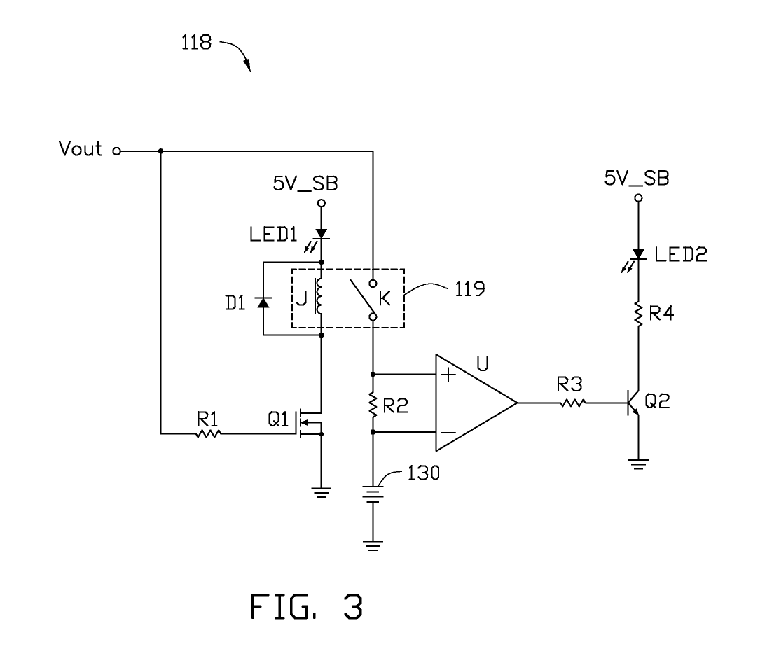

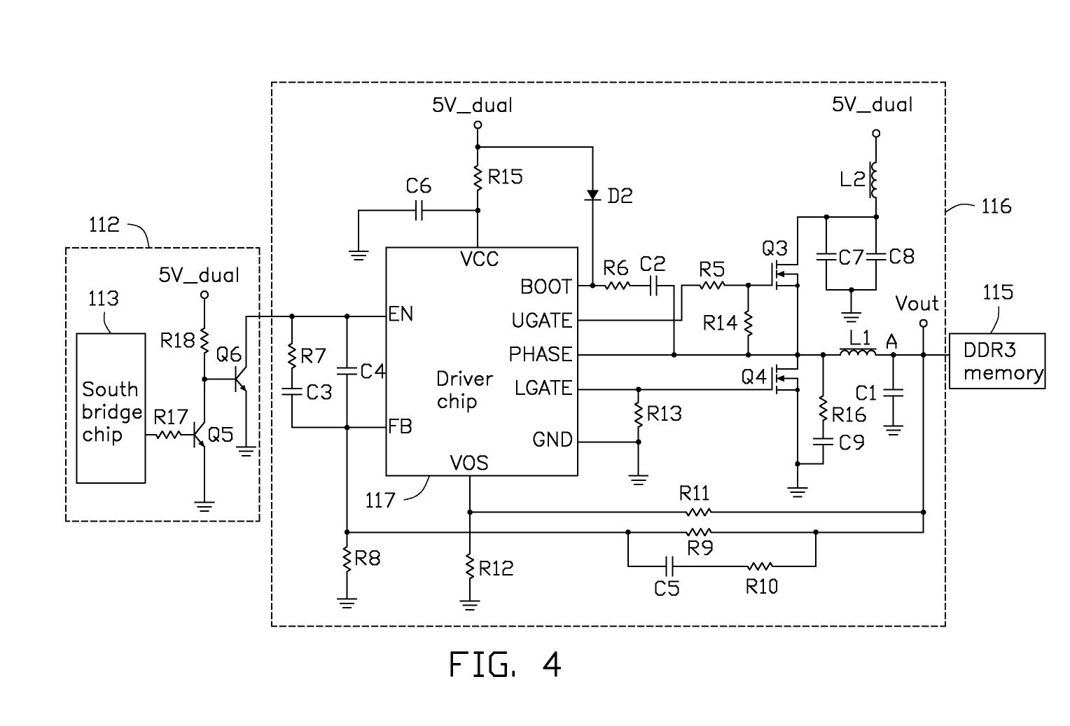

FIGS. 2 through 4 show an embodiment of the charging circuit 110. The charging circuit 110 comprises a control unit 112, a voltage conversion unit 116, and a charging and display unit 118. The voltage conversion unit 116 can be electrically connected to the control unit 112 and the charging and display unit 118. The charging and display unit 118 can be electrically connected to the rechargeable battery 130. The control unit 112 can be used for controlling operation of the voltage conversion unit 116. The voltage conversion unit 116 can be used for converting a voltage of a dual 5 volt (V) power supply 5V_dual of a motherboard into a charging voltage Vout of the rechargeable battery 130, and outputting the charging voltage Vout to the charging and display unit 118. The charging and display unit 118 can be used for charging the rechargeable battery 130 with the charging voltage Vout, when the charging and display unit 118 receives the charging voltage Vout. The charging and display unit 118 can be used for preventing a leakage of the rechargeable battery 130 when the charging and display unit 118 does not receive the charging voltage Vout. The charging and display unit 118 can be further used for displaying a charging state of the rechargeable battery 130.

The charging and display unit 118 comprises a first electronic switch Q1, a second electronic switch Q2, a first light-emitting diode LED1, a second light-emitting diode LED2, a relay 119, a first diode D1, a comparator U, and first through fourth resistors R1-R4. The relay 119 comprises a coil J and a switch K. Each of the first electronic switch Q1 and the second electronic switch Q2 comprises a first terminal, a second terminal, and a third terminal. The first terminal of the first electronic switch Q1 can be electrically connected to the voltage conversion unit 116 through the first resistor R1 to receive the charging voltage Vout. The second terminal of the first electronic switch Q1 can be electrically connected to a cathode of the first light-emitting diode LED1 through the coil J, and further electrically connected to an anode of the first diode D1. The third terminal of the first electronic switch Q1 can be grounded. An anode of the first light-emitting diode LED1 can be electrically connected to a 5V standby power supply 5V_SB of the motherboard. A cathode of the first diode D1 can be electrically connected to the cathode of the first light-emitting diode LED1. A non-inverting terminal of the comparator U can be electrically connected to the voltage conversion unit 116 through the switch K to receive the charging voltage Vout, and further electrically connected to an inverting terminal of the comparator U through the second resistor R2. The inverting terminal of the comparator U can be electrically connected to a positive terminal of the rechargeable battery 130. A negative terminal of the rechargeable battery 130 can be grounded. The first terminal of the second electronic switch Q2 can be electrically connected to an output terminal of the comparator U through the third resistor R3. The second terminal of the second electronic switch Q2 can be electrically connected to a cathode of the second light-emitting diode LED2 through the fourth resistor R4. The third terminal of the second electronic switch Q2 can be grounded. An anode of the second light-emitting diode LED2 can be electrically connected to the 5V standby power supply 5V_SB.

The voltage conversion unit 116 comprises a driver chip 117, a third electronic switch Q3, a fourth electronic switch Q4, a first inductor L1, a second inductor L2, a second diode D2, first through ninth capacitors C1-C9, and fifth through sixteenth resistors R5-R16. The driver chip 117 comprises a first control pin UGATE, a second control pin LGATE, a phase pin PHASE, a bootstrap pin BOOT, an enable pin EN, a feedback pin FB, a detecting pin VOS, a power pin VCC, and a ground pin GND. Each of the third electronic switch Q3 and the fourth electronic switch Q4 comprises a first terminal, a second terminal, and a third terminal

The first terminal of the third electronic switch Q3 can be electrically connected to the first control pin UGATE of the driver chip 117 through the fifth resistor R5. The second terminal of the third electronic switch Q3 can be electrically connected to the dual 5V power supply 5V_dual through the second inductor L2, can be grounded through the seventh capacitor C7, and can be grounded through the eighth capacitor C8. The third terminal of the third electronic switch Q3 can be grounded through the first inductor L1 and the first capacitor C1 in that order. The first terminal of the fourth electronic switch Q4 can be electrically connected to the second control pin LGATE of the driver chip 117. The second terminal of the fourth electronic switch Q4 can be electrically connected to the third terminal of the third electronic switch Q3, and further electrically connected to the phase pin PHASE of the driver chip 117. The third terminal of the fourth electronic switch Q4 can be grounded. A node A between the first inductor L1 and the first capacitor C1 functions as an output terminal of the voltage conversion unit 116, and can be electrically connected to the charging and display unit 118 to output the charging voltage Vout to the charging and display unit 118. An anode of the second diode D2 can be electrically connected to the dual 5V power supply 5V_dual. A cathode of the second diode D2 can be electrically connected to the bootstrap pin BOOT of the driver chip 117. The bootstrap pin BOOT of the driver chip 117 can be electrically connected to the phase pin PHASE of the driver chip 117 through the sixth resistor R6 and the second capacitor C2 in that order. The enable pin EN of the driver chip 117 can be electrically connected to the feedback pin FB of the driver chip 117 through the seventh resistor R7 and the third capacitor C3 in that order, and further electrically connected to the feedback pin FB of the driver chip 117 through the fourth capacitor C4. The feedback pin FB of the driver chip 117 can be grounded through the eighth resistor R8 and electrically connected to the node A through the ninth resistor R9, and further electrically connected to the node A through the fifth capacitor C5 and the tenth resistor R10 in that order. The detecting pin VOS of the driver chip 117 can be electrically connected to the node A through the eleventh resistor R11 and grounded through the twelfth resistor R12. The second control pin LGATE of the driver chip 117 can be grounded through the thirteenth resistor R13. The phase pin PHASE of the driver chip 117 can be electrically connected to the first terminal of the third electronic switch Q3 through the fourteenth resistor R14. The power pin VCC of the driver chip 117 can be electrically connected to the dual 5V power supply 5V_dual through the fifteenth resistor R15 and grounded through the sixth capacitor C6. The ground pin GND of the driver chip 117 can be grounded. The second terminal of the fourth electronic switch Q4 can be grounded through the sixteenth resistor R16 and the ninth capacitor C9 in that order.

The control unit 112 comprises a south bridge chip 113, a fifth electronic switch Q5, a sixth electronic switch Q6, a seventeenth resistor R17, and an eighteenth resistor R18. Each of the fifth electronic switch Q5 and the sixth electronic switch Q6 comprises a first terminal, a second terminal, and a third terminal The first terminal of the fifth electronic switch Q5 can be electrically connected to the south bridge chip 113 through the seventeenth resistor R17 to receive control signals from the south bridge chip 113. The second terminal of the fifth electronic switch Q5 can be electrically connected to the dual 5V power supply 5V_dual through the eighteenth resistor R18. The third terminal of the fifth electronic switch Q5 can be grounded. The first terminal of the sixth electronic switch Q6 can be electrically connected to the second terminal of the fifth electronic switch Q5. The second terminal of the sixth electronic switch Q6 can be electrically connected to the enable pin EN of the driver chip 117, to output an enable signal to the enable pin EN of the driver chip 117. The third terminal of the sixth electronic switch Q6 can be grounded.

When the rechargeable battery 130 needs to be charged, the rechargeable battery 130 can be received in the receiving space 120 and electrically connected to the charging circuit 110.

When the south bridge chip 113 outputs a first control signal to the first terminal of the fifth electronic switch Q5, the fifth electronic switch Q5 is turned off, and the sixth electronic switch Q6 is turned on. The second terminal of the sixth electronic switch Q6 outputs the enable signal to the enable pin EN of the driver chip 117, and the driver chip 117 starts to operate. When the south bridge chip 113 outputs a second control signal to the first terminal of the fifth electronic switch Q5, the fifth electronic switch Q5 is turned on, and the sixth electronic switch Q6 is turned off The second terminal of the sixth electronic switch Q6 does not output the enable signal to the enable pin EN of the driver chip 117, and the driver chip 117 does not operate.

When the driver chip 117 operates, the first control pin UGATE and the second control pin LGATE of the driver chip 117 alternately output high-level signals to alternately turn on the third electronic switch Q3 and the fourth electronic switch Q4. When the first control pin UGATE outputs a high-level signal, such as logic 1, and the second control pin LGATE outputs a low-level signal, such as logic 0, the third electronic switch Q3 is turned on, and the fourth electronic switch Q4 is turned off. The dual 5V power supply 5V_dual supplies power to charge the first inductor L1 and the first capacitor C1 through the third electronic switch Q3. When the first control pin UGATE outputs a low-level signal and the second control pin LGATE outputs a high-level signal, the third electronic switch Q3 is turned off, and the fourth electronic switch Q4 is turned on, which causes the first inductor L1 and the first capacitor C1 to discharge through the fourth electronic switch Q4. The node A can then output the charging voltage Vout. When the driver chip 117 does not operate, the node A does not output the charging voltage Vout.

When the voltage conversion unit 116 outputs the charging voltage Vout, the first electronic switch Q1 is turned on, a current passes through the coil J, the switch K2 is turned on, and thus the rechargeable battery 130 is charged by the charging voltage Vout through the switch K and the second resistor R2 in that order. The first light-emitting diode LED1 can be lit up to indicate that the charging and display unit 118 receives the charging voltage Vout. When the rechargeable battery 130 is charging and not fully charged, a voltage at the non-inverting terminal of the comparator U can be greater than a voltage at the inverting terminal of the comparator U, and the output terminal of comparator U outputs a high-level signal, such as logic 1, to the first terminal of the second electronic switch Q2. The second electronic switch Q2 is turned on, and the second light-emitting diode LED2 can be lit up to indicate that the rechargeable battery 130 is being charged. When the rechargeable battery 130 is fully charged, the voltage at the non-inverting terminal of the comparator U can be substantially equal to the voltage at the inverting terminal of the comparator U, and the output terminal of comparator U outputs a low-level signal, such as logic 0, to the first terminal of the second electronic switch Q2. The second electronic switch Q2 is turned off, and the second light-emitting diode LED2 is not lit up, which indicates that the rechargeable battery 130 is fully charged.

When the voltage conversion unit 116 does not output the charging voltage Vout, the first electronic switch Q1 is turned off, and the first light-emitting diode LED1 is not lit up, which indicates that the charging and display unit 118 does not receive the charging voltage Vout. Thus, no current passes through the coil J, and the switch K is turned off to prevent a leakage of the rechargeable battery 130. The voltage at the non-inverting terminal of the comparator U can be substantially equal to the voltage at the inverting terminal of the comparator U, and the output terminal of comparator U outputs a low-level signal to the first terminal of the second electronic switch Q2, which causes the second electronic switch Q2 to turn off. Thus, the second light-emitting diode LED2 is not lit up.

In one embodiment, each of the first electronic switch Q1, the third electronic switch Q3, and the fourth electronic switch Q4 can be an n-channel metal-oxide semiconductor field-effect transistor (NMOSFET), and the first terminal, the second terminal, and the third terminal of the first electronic switch Q1, the third electronic switch Q3, and the fourth electronic switch Q4 correspond to a gate, a drain, and a source of the NMOSFET, respectively. Each of the second electronic switch Q2, the fifth electronic switch Q5, and the sixth electronic switch Q6 can be an npn-type bipolar junction transistor (BJT), and the first terminal, the second terminal, and the third terminal of each of the second electronic switch Q2, the fifth electronic switch Q5, and the sixth electronic switch Q6 correspond to a base, a collector, and an emitter of the npn-type BJT, respectively. The first control signal can be a low-level signal, such as logic 0. The second control signal can be a high-level signal, such as logic 1. In other embodiments, each of the first electronic switch Q1, the third electronic switch Q3, and the fourth electronic switch Q4 can be an npn-type BJT or other suitably switch having similar functions. Each of the second electronic switch Q2, the fifth electronic switch Q5, and the sixth electronic switch Q6 can be an NMOSFET or other suitable switch having similar functions. A voltage level of each of the first control signal and the second control signal can be adjusted according to actual needs.

In one embodiment, the charging voltage Vout can be further used to supply power to an electronic element, such as a double data rate 3 (DDR3) memory 115 of the electronic device 10. When the electronic device 10 is in power states S0-S3 defined by advanced configuration and power interface (ACPI), the south bridge chip 113 outputs a low-level signal to the first terminal of the fifth electronic switch Q5. When the electronic device 10 is in power states S4-S5 defined by ACPI, the south bridge chip 113 outputs a high-level signal to the first terminal of the fifth electronic switch Q5.

In one embodiment, the first diode D1 can be used for discharging electrical energy stored in the coil J. The second diode D2, the sixth resistor R6, and the second capacitor C2 form a bootstrap circuit for raising a voltage of the bootstrap pin BOOT of the driver chip 117. The third capacitor C3, the fourth capacitor C4, and the seventh resistor R7 form a compensation circuit for improving accuracy of voltage and current output from the voltage conversion unit 116. The second inductor L2, the seventh capacitor C7, and the eighth capacitor C8 form a filter circuit for filtering voltage spikes generated by the third electronic switch Q3 when the third electronic switch Q3 switches between an on-state and an off-state. The sixteenth resistor R16 and the ninth capacitor C9 form a buffer circuit for buffering a voltage spike generated by the fourth electronic switch Q4 when the fourth electronic switch Q4 switches between an on-state and an off-state. The fifteenth resistor R15 and the sixth capacitor C6 form a low pass filter for filtering noise in the dual 5V power supply 5V_dual.

As detailed above, by employing the voltage conversion unit 116 to convert the dual 5V power supply 5V_dual into the charging voltage Vout, and by employing the charging and display unit 118 to charge the rechargeable battery 130 with the charging voltage Vout and display charging states of the rechargeable battery 130, the rechargeable battery 130 can be charged by the electronic device 10 directly. Thus, a dedicated charger is not needed.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A charging circuit for charging a rechargeable battery, the charging circuit comprising:
a voltage conversion unit to convert a voltage of a first power supply into a charging voltage of the rechargeable battery, and to output the charging voltage;
a control unit electrically connected to the voltage conversion unit to control the voltage conversion unit to operate; and
a charging and display unit electrically connected to the voltage conversion unit and the rechargeable battery, to display charging state of the rechargeable battery;
wherein in response to the voltage conversion unit outputting the charging voltage, the charging and display unit receives the charging voltage from the voltage conversion unit and charges the rechargeable battery with the charging voltage; and wherein in response to the voltage conversion unit not outputting the charging voltage, the charging and display unit prevents a leakage of the rechargeable battery.

2. The charging circuit of claim 1, wherein the charging and display unit comprises:
a first resistor, a second resistor, a third resistor, and a fourth resistor;
a first light-emitting diode comprising an anode electrically connected to a second power supply, and a cathode;
a second light-emitting diode comprising an anode electrically connected to the second power supply, and a cathode;
a diode comprising an anode and a cathode electrically connected to the cathode of the first light-emitting diode;
a relay comprising a coil and a switch;
a first electronic switch comprising a first terminal electrically connected to the voltage conversion unit through the first resistor to receive the charging voltage, a second terminal electrically connected to the cathode of the first light-emitting diode through the coil and electrically connected to the anode of the diode, and a third terminal grounded;
a comparator comprising a non-inverting terminal electrically connected to the voltage conversion unit through the switch of the relay to receive the charging voltage, an inverting terminal electrically connected to a positive terminal of the rechargeable battery and electrically connected the non-inverting terminal through the second resistor, and an output terminal; wherein a negative of the rechargeable battery is grounded;
a second electronic switch comprising a first terminal electrically connected to the output terminal of the comparator, a second terminal electrically connected to the cathode of the second light-emitting diode through the fourth resistor, and a third terminal which is grounded;
wherein in response to the voltage conversion unit outputting the charging voltage, the first electronic switch is turned on, a current passes through the coil, the switch is turned on, the rechargeable battery is charged by the charging voltage through the switch and the second resistor, and the first light-emitting diode is lit up to indicate the charging voltage is received by the charging and display unit;
wherein in response to the rechargeable battery being charging and not full, the output terminal of the comparator outputs a high-level signal, the second electronic switch is turned on, and the second light-emitting diode is lit up to indicate the rechargeable battery is being charged;
wherein in response to the rechargeable battery is fully charged, the output terminal of the comparator outputs a low-level signal, the second electronic switch is turned off, and the second light-emitting diode is not lit up to indicate the rechargeable battery is fully charged; and
wherein in response to the voltage conversion unit not outputting the charging voltage, the first electronic switch is turned off, the first light-emitting diode is not lit up to indicate the charging voltage is received by the charging and display unit, no current passes through the coil, the switch is turned off to prevent a leakage of the rechargeable battery, the output terminal of the comparator outputs the low-level signal, the second electronic switch is turned off, and the second light-emitting diode is not lit up.

3. The charging circuit of claim 2, wherein the first electronic switch is an n-channel metal-oxide semiconductor field-effect transistor (NMOSFET), and the first terminal, the second terminal, and the third terminal of the second electronic switch are respectively corresponding to a gate, a drain, and a source of the NMOSFET, the second electronic switch is an npn-type bipolar junction transistor (BJT), and the first terminal, the second terminal, and the third terminal of the second electronic switch are respectively corresponding to a base, a collector, and an emitter of the npn-type BJT.

4. The charging circuit of claim 1, wherein the voltage conversion unit comprises:
a first inductor;
a first capacitor;
a first resistor;
a driver chip comprising a first control pin, a second control pin, and a phase pin;
a first electronic switch comprising a first terminal electrically connected to the first control pin of the driver chip through the first resistor, a second terminal electrically connected to the first power supply, and a third terminal grounded through the first inductor and the first capacitor in that order;
a second electronic switch comprising a first terminal electrically connected to the second control pin of the driver chip, a second terminal electrically connected to the third terminal of the first electronic switch and electrically connected to the phase pin of the driver chip, and a third terminal which is grounded;
wherein a node between the first inductor and the first capacitor functions as the output terminal of the voltage conversion unit, and is electrically connected to the charging and display unit;
wherein in response to the driver chip operating, the first control pin and the second control pin of the driver chip alternately output high-level signals to alternately turn on the third electronic switch or the fourth electronic switch; in response to the first control pin of the driver chip outputting a high-level signal, and the second control pin of the driver chip outputting a low-level signal, the first electronic switch is turned on, the second electronic switch is turned off, the first inductor and the first capacitor are charged by the first power supply through the first electronic switch; in response to the first control pin of the driver chip outputting a low-level signal, and the second control pin of the driver chip outputting a high-level signal, the first electronic switch is turned off, the second electronic switch is turned on, the first inductor and the first capacitor are discharged through the second electronic switch; and thus the output terminal of the voltage conversion unit outputs the charging voltage; and
wherein in response to the driver chip not operating, the output terminal of the voltage conversion unit does not output the charging voltage.

5. The charging circuit of claim 4, wherein the voltage conversion unit further a bootstrap circuit, a compensation circuit, a low pass filter, a filter circuit, a buffer circuit, a second capacitor, a second resistor, a third resistor, a fourth resistor, a fifth resistor, a sixth resistor, a seventh resistor, and an eighth resistor; and
the driver chip further comprises:
a bootstrap pin electrically connected to the phase pin of the driver chip through the bootstrap circuit;
a feedback pin grounded through the second resistor, electrically connected to the output terminal of the voltage conversion unit through the third resistor, and electrically connected to the output terminal of the voltage conversion unit through the second capacitor and the fourth resistor in that order;
an enable pin electrically connected to the feedback pin of the driver chip through the compensation circuit;
a detecting pin electrically connected to the output terminal of the voltage conversion unit through the fifth resistor, and grounded through the sixth resistor;
a power pin electrically connected to the first power supply through the low pass filter; and
a grounded ground pin;
wherein the second control pin of the driver chip is grounded through the seventh resistor, the phase pin of the driver chip is electrically connected to the first terminal of the first electronic switch through the eighth resistor, the second terminal of the first electronic switch is electrically connected to the first power supply through the filter circuit, and the second terminal of the second electronic switch grounded through the buffer circuit.

6. The charging circuit of claim 5, wherein the bootstrap circuit comprises a diode comprising an anode electrically connected to the first power supply and a cathode, a ninth resistor, and a third capacitor; the compensation circuit comprises a fourth capacitor, a fifth capacitor, and a tenth resistor; the low pass filter comprises an eleventh resistor and a sixth capacitor; the filter circuit comprises a second inductor, a seventh capacitor, and an eighth capacitor; the buffer circuit comprises a twelfth resistor and a ninth capacitor; the bootstrap pin of the driver chip is electrically connected to the cathode of the diode, and electrically connected to the phase pin of the driver chip through the ninth resistor and the third capacitor in that order; the enable pin of the driver chip is electrically connected to the feedback pin of the driver chip through the fourth capacitor, and electrically connected to the feedback pin of the driver chip through the tenth resistor and the fifth capacitor in that order; the power pin of the driver chip is electrically connected to the first power supply through the eleventh resistor and grounded through the sixth capacitor; the second terminal of the first electronic switch is electrically connected to the first power supply through the second inductor, grounded through the seventh capacitor, and grounded through the eighth capacitor; the second terminal of the second electronic switch is grounded through the twelfth resistor and the ninth capacitor in that order.

7. The charging circuit of claim 6, wherein each of the first electronic switch and the second electronic switch is an NMOSFET, and the first terminal, the second terminal, and the third terminal of each of the first electronic switch and the second electronic switch are respectively corresponding to a gate, a drain, and a source of the NMOSFET.

8. The charging circuit of claim 5, wherein the control unit comprises:
a south bridge chip;
a ninth resistor and a tenth resistor;
a third electronic switch comprising a first terminal electrically connected to the south bridge chip through the ninth resistor to receive a first control signal and a second control signal from the south bridge chip, a second terminal electrically connected to the first power supply through the tenth resistor, and a third terminal grounded;
a fourth electronic switch comprising a first terminal electrically connected to the second terminal of the third electronic switch, a second terminal electrically connected to the enable pin of the driver chip to output an enable signal to the enable pin o f the driver chip, and a third terminal grounded;
wherein in response to the south bridge chip outputting the first control signal to the first terminal of the third electronic switch, the third electronic switch is turned off, the fourth electronic switch is turned on, the second terminal of the fourth electronic switch outputs the enable signal to the enable pin of the driver chip, and the driver chip starts to operate; and
wherein in response to the south bridge chip outputting the second control signal to the first terminal of the third electronic switch, the third electronic switch is turned on, the fourth electronic switch is turned off, the second terminal of the fourth electronic switch does not output the enable signal, and the driver chip does not operate.

9. The charging circuit of claim 8, wherein each of the third electronic switch and the fourth electronic switch is an npn-type BJT, and the first terminal, the second terminal, and the third terminal of each of the third electronic switch and the fourth electronic switch are respectively corresponding to a base, a collector, and an emitter of the npn-type BJT.

10. An electronic device comprising:
a shell comprising a receiving space to receive a rechargeable battery;
a charging circuit received in the shell and electrically connected to the rechargeable battery to charge the rechargeable battery, the charging circuit comprising:
a voltage conversion unit to convert a voltage of a first power supply into a charging voltage of the rechargeable battery, and to output the charging voltage;
a control unit electrically connected to the voltage conversion unit to control the voltage conversion unit to operate; and
a charging and display unit electrically connected to the voltage conversion unit and the rechargeable battery, to display charging state of the rechargeable battery;
wherein in response to the voltage conversion unit outputting the charging voltage, the charging and display unit receives the charging voltage from the voltage conversion unit and charges the rechargeable battery with the charging voltage; and wherein in response to the voltage conversion unit not outputting the charging voltage, the charging and display unit prevents a leakage of the rechargeable battery.

11. The electronic device of claim 10, wherein the charging and display unit comprises:
a first resistor, a second resistor, a third resistor, and a fourth resistor;
a first light-emitting diode comprising an anode electrically connected to a second power supply, and a cathode;
a second light-emitting diode comprising an anode electrically connected to the second power supply, and a cathode;
a diode comprising an anode and a cathode electrically connected to the cathode of the first light-emitting diode;
a relay comprising a coil and a switch;
a first electronic switch comprising a first terminal electrically connected to the voltage conversion unit through the first resistor to receive the charging voltage, a second terminal electrically connected to the cathode of the first light-emitting diode through the coil and electrically connected to the anode of the diode, and a third terminal grounded;
a comparator comprising a non-inverting terminal electrically connected to the voltage conversion unit through the switch of the relay to receive the charging voltage, an inverting terminal electrically connected to a positive terminal of the rechargeable battery and electrically connected the non-inverting terminal through the second resistor, and an output terminal; wherein a negative of the rechargeable battery is grounded;
a second electronic switch comprising a first terminal electrically connected to the output terminal of the comparator, a second terminal electrically connected to the cathode of the second light-emitting diode through the fourth resistor, and a third terminal which is grounded;
wherein in response to the voltage conversion unit outputting the charging voltage, the first electronic switch is turned on, a current passes through the coil, the switch is turned on, the rechargeable battery is charged by the charging voltage through the switch and the second resistor, and the first light-emitting diode is lit up to indicate the charging voltage is received by the charging and display unit;
wherein in response to the rechargeable battery being charging and not full, the output terminal of the comparator outputs a high-level signal, the second electronic switch is turned on, and the second light-emitting diode is lit up to indicate the rechargeable battery is being charged;
wherein in response to the rechargeable battery is fully charged, the output terminal of the comparator outputs a low-level signal, the second electronic switch is turned off, and the second light-emitting diode is not lit up to indicate the rechargeable battery is fully charged; and
wherein in response to the voltage conversion unit not outputting the charging voltage, the first electronic switch is turned off, the first light-emitting diode is not lit up to indicate the charging voltage is received by the charging and display unit, no current passes through the coil, the switch is turned off to prevent a leakage of the rechargeable battery, the output terminal of the comparator outputs the low-level signal, the second electronic switch is turned off, and the second light-emitting diode is not lit up.

12. The electronic device of claim 11, wherein the first electronic switch is an n-channel metal-oxide semiconductor field-effect transistor (NMOSFET), and the first terminal, the second terminal, and the third terminal of the second electronic switch are respectively corresponding to a gate, a drain, and a source of the NMOSFET, the second electronic switch is an npn-type bipolar junction transistor (BJT), and the first terminal, the second terminal, and the third terminal of the second electronic switch are respectively corresponding to a base, a collector, and an emitter of the npn-type BJT.

13. The electronic device of claim 10, wherein the voltage conversion unit comprises:
a first inductor;
a first capacitor;
a first resistor;
a driver chip comprising a first control pin, a second control pin, and a phase pin;
a first electronic switch comprising a first terminal electrically connected to the first control pin of the driver chip through the first resistor, a second terminal electrically connected to the first power supply, and a third terminal grounded through the first inductor and the first capacitor in that order;
a second electronic switch comprising a first terminal electrically connected to the second control pin of the driver chip, a second terminal electrically connected to the third terminal of the first electronic switch and electrically connected to the phase pin of the driver chip, and a third terminal which is grounded;
wherein a node between the first inductor and the first capacitor functions as the output terminal of the voltage conversion unit, and is electrically connected to the charging and display unit;
wherein in response to the driver chip operating, the first control pin and the second control pin of the driver chip alternately output high-level signals to alternately turn on the third electronic switch or the fourth electronic switch; in response to the first control pin of the driver chip outputting a high-level signal, and the second control pin of the driver chip outputting a low-level signal, the first electronic switch is turned on, the second electronic switch is turned off, the first inductor and the first capacitor are charged by the first power supply through the first electronic switch; in response to the first control pin of the driver chip outputting a low-level signal, and the second control pin of the driver chip outputting a high-level signal, the first electronic switch is turned off, the second electronic switch is turned on, the first inductor and the first capacitor are discharged through the second electronic switch; and thus the output terminal of the voltage conversion unit outputs the charging voltage; and
wherein in response to the driver chip not operating, the output terminal of the voltage conversion unit does not output the charging voltage.

14. The electronic device of claim 13, wherein the voltage conversion unit further a bootstrap circuit, a compensation circuit, a low pass filter, a filter circuit, a buffer circuit, a second capacitor, a second resistor, a third resistor, a fourth resistor, a fifth resistor, a sixth resistor, a seventh resistor, and an eighth resistor; and
the driver chip further comprises:
a bootstrap pin electrically connected to the phase pin of the driver chip through the bootstrap circuit;
a feedback pin grounded through the second resistor, electrically connected to the output terminal of the voltage conversion unit through the third resistor, and electrically connected to the output terminal of the voltage conversion unit through the second capacitor and the fourth resistor in that order;
an enable pin electrically connected to the feedback pin of the driver chip through the compensation circuit;
a detecting pin electrically connected to the output terminal of the voltage conversion unit through the fifth resistor, and grounded through the sixth resistor;
a power pin electrically connected to the first power supply through the low pass filter; and
a grounded ground pin;
wherein the second control pin of the driver chip is grounded through the seventh resistor, the phase pin of the driver chip is electrically connected to the first terminal of the first electronic switch through the eighth resistor, the second terminal of the first electronic switch is electrically connected to the first power supply through the filter circuit, and the second terminal of the second electronic switch grounded through the buffer circuit.

15. The electronic device of claim 14, wherein the bootstrap circuit comprises a diode comprising an anode electrically connected to the first power supply and a cathode, a ninth resistor, and a third capacitor; the compensation circuit comprises a fourth capacitor, a fifth capacitor, and a tenth resistor; the low pass filter comprises an eleventh resistor and a sixth capacitor; the filter circuit comprises a second inductor, a seventh capacitor, and an eighth capacitor; the buffer circuit comprises a twelfth resistor and a ninth capacitor; the bootstrap pin of the driver chip is electrically connected to the cathode of the diode, and electrically connected to the phase pin of the driver chip through the ninth resistor and the third capacitor in that order; the enable pin of the driver chip is electrically connected to the feedback pin of the driver chip through the fourth capacitor, and electrically connected to the feedback pin of the driver chip through the tenth resistor and the fifth capacitor in that order; the power pin of the driver chip is electrically connected to the first power supply through the eleventh resistor and grounded through the sixth capacitor; the second terminal of the first electronic switch is electrically connected to the first power supply through the second inductor, grounded through the seventh capacitor, and grounded through the eighth capacitor; the second terminal of the second electronic switch is grounded through the twelfth resistor and the ninth capacitor in that order.

16. The electronic device of claim 15, wherein each of the first electronic switch and the second electronic switch is an NMOSFET, and the first terminal, the second terminal, and the third terminal of each of the first electronic switch and the second electronic switch are respectively corresponding to a gate, a drain, and a source of the NMOSFET.

17. The electronic device of claim 14, wherein the control unit comprises:
a south bridge chip;
a ninth resistor and a tenth resistor;
a third electronic switch comprising a first terminal electrically connected to the south bridge chip through the ninth resistor to receive a first control signal and a second control signal from the south bridge chip, a second terminal electrically connected to the first power supply through the tenth resistor, and a third terminal grounded;
a fourth electronic switch comprising a first terminal electrically connected to the second terminal of the third electronic switch, a second terminal electrically connected to the enable pin of the driver chip to output an enable signal to the enable pin o f the driver chip, and a third terminal grounded;
wherein in response to the south bridge chip outputting the first control signal to the first terminal of the third electronic switch, the third electronic switch is turned off, the fourth electronic switch is turned on, the second terminal of the fourth electronic switch outputs the enable signal to the enable pin of the driver chip, and the driver chip starts to operate; and
wherein in response to the south bridge chip outputting the second control signal to the first terminal of the third electronic switch, the third electronic switch is turned on, the fourth electronic switch is turned off, the second terminal of the fourth electronic switch does not output the enable signal, and the driver chip does not operate.

18. The electronic device of claim 17, wherein each of the third electronic switch and the fourth electronic switch is an npn-type BJT, and the first terminal, the second terminal, and the third terminal of each of the third electronic switch and the fourth electronic switch are respectively corresponding to a base, a collector, and an emitter of the npn-type BJT.
